(19) United States
(12) Patent Application Publication
(10) Pub. No.: US 2026/0148340 A1
(43) Pub. Date: May 28, 2026

(54) IMAGE GENERATION METHOD

(71) Applicant: Samsung Electronics Co., Ltd., Suwon-si (KR)

(72) Inventors: Kwang-Eun Kim, Suwon-si (KR); Sewon Kim, Suwon-si (KR); SEO YOUNG PARK, Suwon-si (KR); JEONGHO AHN, Suwon-si (KR); SUNGEUN LEE, Suwon-si (KR)

(21) Appl. No.: 19/234,870

(22) Filed: Jun. 11, 2025

(30) Foreign Application Priority Data
Nov. 28, 2024 (KR) 10-2024-0174069

(51) Int. Cl. G06T 5/10; G06T 5/40

(52) U.S. Cl. CPC G06T 5/10; G06T 5/40; G06T 2207/10061

(57) ABSTRACT

An image generation method using a scanning electron microscope includes generating a first image by imaging a wafer sample at a low frame rate, generating a sample image by imaging a reference sample at a high frame rate, and generating a second image having a high signal-to-noise-ratio using phase information extracted from the first image and amplitude information extracted from the sample image, wherein the number of patterns included in the first image and the number of patterns included in the sample image are the same.

### CROSS-REFERENCE TO RELATED APPLICATION

This application claims priority under 35 U.S.C. § 119 to Korean Patent Application No. 10-2024-0174069, filed on Nov. 28, 2024, in the Korean Intellectual Property Office, the entire disclosure of which is incorporated by reference herein its entirety.

### TECHNICAL FIELD

The present disclosure relates to an image generation method using a scanning electron microscope.

### DISCUSSION OF THE RELATED ART

As semiconductor processes are scaled down, wafer inspection and metrology are becoming more important. Particularly in a patterning process, a scanning electron microscope (SEM) is widely used to measure a microstructure.

The scanning electron microscope (SEM) is a microscope that scans a surface of a sample with an electron beam to create an image. When high-speed electrons are fired onto the sample from an electron gun and collide with the sample surface, secondary electrons are ejected from the sample surface. By analyzing the secondary electrons ejected from the sample surface, the shape of the wafer surface may be imaged, and the pattern size of the sample may be measured.

There are two methods by which the SEM may generate images depending on a number of frames used for generating the images. One method, which is referred to as a low-frame image generation method, is to generate an image with a small number of frames, and the other method, which is referred to as a high-frame image generation method, is to generate an image with a large number of frames. For example, the high-frame image generation method may acquire dozens of frames for generating an image while low-frame image generation method use a single frame or a small number of frames for generating an image. For the high-frame image generation method, the acquired dozens of frames may be averaged to generate the image. The low-frame image generation method is advantageous in terms of a high-speed measurement because it uses a single frame or a small number of frames for generating an image. However, the image, generated by low-frame image generation method, may include a lot of noise signals, therefrom causing measurement errors in an output image.

On the contrary, the high-frame image generation method is advantageous in reducing noise in the output image, because the method acquires dozens of frames and averages the dozens of frames to generate the output image. However, the high-frame image generation method requires relatively long processing time to generate an image, because the method has to process a large number of frames. Furthermore, a large amount of electron beam injected into the sample may cause a damage on patterns of the sample.

Accordingly, in a scanning process of a SEM for generating an image, a method that can minimize damage to a sample while accelerating the image generation speed and reducing noise signals is needed.

### SUMMARY OF THE INVENTION

Embodiments of the present disclosure provide an image generation method which includes generating a low-frame image of a wafer sample, generating a high-frame image of a reference sample having the same pattern as the wafer sample, and generating a high-quality image with a high signal-to-noise ratio by using phase information extracted from the low-frame image and amplitude information extracted from the high-frame image.

An image generation method according to an embodiment includes generating a first image by imaging a wafer sample at a low frame rate, generating a sample image by imaging a reference sample at a high-frame rate; and generating a second image using phase information extracted from the first image and amplitude information extracted from the sample image, in which a signal-to-noise ratio of the second image is higher than that of the first image, wherein the number of patterns included in the first image and the number of patterns included in the sample image are the same.

An image generation method according to an embodiment includes generating a first image by imaging a wafer sample, in which the first image includes a first number of patterns, generating a sample image by imaging a reference sample, in which the sample image includes a second number of patterns, extracting phase information from the first image, extracting amplitude information from the sample image, and generating a second image using the phase information and the amplitude information, wherein the first number and the second number are the same.

An image generation method according to an embodiment includes generating a first image at a low frame rate from a wafer sample, generating a wafer image at a high-frame rate from the wafer sample, extracting phase information from the first image, extracting amplitude information from the wafer image, and generating a second image using the phase information and the amplitude information.

According to the embodiments, the present disclosure provides an image generation method using a scanning electron microscope that images a wafer sample at a low frame rate, images an object identical to the wafer pattern at a high-frame rate, and removes a noise signal from the wafer image using amplitude information, thereby minimizing wafer surface damage and generating high-quality wafer images at high speed.

### BRIEF DESCRIPTION OF THE DRAWINGS

FIG. 1A and FIG. 1B are provided for description of an image acquisition process using a conventional scanning electron microscope.

FIG. 2 is provided for description of an image generation method according to an embodiment.

FIG. 3 is provided for description of a second image generated when the number of patterns of the first image and the number of patterns of the sample image are the same in the method according to FIG. 2.

FIG. 4 is provided for description of a second image generated when the number of patterns of the first image and the number of patterns of the sample image are different in the method according to FIG. 2.

FIG. 5 is provided for description of the image generation method according to an embodiment.

FIG. 6A and FIG. 6B are provided for description of a process for generating the first image and the sample image using the image generation method according to an embodiment.

FIG. 7 is provided for description of a method for extracting phase information from the first image in the image generation method according to an embodiment.

FIG. 8 is provided for description of a method for extracting amplitude information from the sample image in the image generation method according to an embodiment.

FIG. 9A and FIG. 9B are provided for description of extraction of phase information and amplitude information using the image generation method of FIG. 7 and FIG. 8.

FIG. 10 is provided for description of a method for generating the second image in the image generation method according to an embodiment.

FIG. 11 is provided for description of a process for generating the second image using the image generation method according to FIG. 10.

FIG. 12 is provided to describe an image generation device that generates an image using the image generation method according to the present disclosure.

FIG. 13 is provided for description of an image generation method according to an embodiment.

FIG. 14 is provided for description of a process for extracting amplitude information in the image generation method of FIG. 13.

FIG. 15 is provided for description of a process for generating a second image using the image generation method of FIG. 13.

FIG. 16 is provided for description of the degree of change in a critical dimension (CD) according to the number of frames for image generation.

### DETAILED DESCRIPTION OF THE EMBODIMENTS

Hereinafter, with reference to the accompanying drawings, various embodiments of the present disclosure are described in detail and a person of ordinary skill in the art can easily practice the present disclosure. The present disclosure may be implemented in many different forms and is not limited to the embodiments described herein.

In order to clearly describe the present disclosure, details that are not related to the description have been omitted, and the same reference symbols are used for identical or similar components throughout the specification.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first”) in a particular claim may be described elsewhere with a different ordinal number (e.g., “second”) in the specification or another claim.

In addition, the size and thickness of each component shown in the drawings are scaled for better understanding and ease of description, and thus the present disclosure is not necessarily limited to embodiments shown in the drawings. In the drawings, the thickness of layers, films, panels, regions, etc., are exaggerated for clarity. In addition, for better understanding and ease of description, the thickness of some layers and regions is exaggerated.

Throughout the specification, the terms “connected,” “contacted,” or “combined” is not limited to “directly connected”, but also includes being “indirectly connected” through another member in between. In addition, unless explicitly described to the contrary, the word “comprise”, and variations such as “comprises” or “comprising”, will be understood to imply the inclusion of stated elements but not the exclusion of any other elements.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Furthermore, when an element is “on” a reference portion, the element is located above or below the reference portion, and it does not necessarily mean that the element is located “above” or “on” in a direction opposite to gravity.

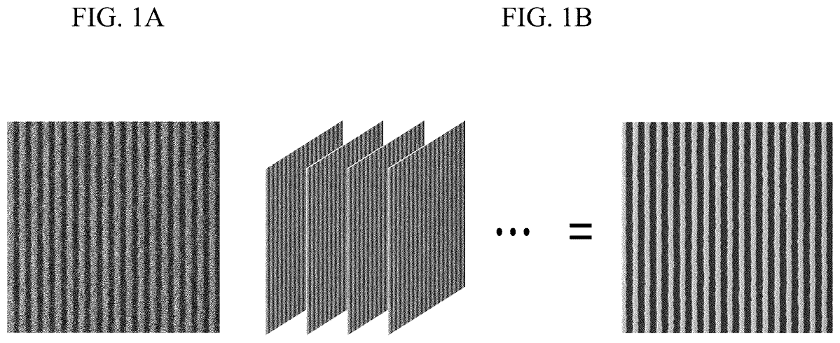

FIG. 1A and FIG. 1B are provided for description of an image acquisition process using a conventional scanning electron microscope.

FIG. 1A shows an image of a wafer sample captured by a conventional scanning method of a scanning electron microscope. The image of a pattern of the wafer sample may be generated from one frame or a small number of frames. A method that generates an image with a single frame is called a low-frame image generation method. Alternatively, a method that generates an image with a small number of frames is called the low-frame image generation method, in which the method is determined as the low-frame image generation method when the number of frames used for generating the image is equal to or smaller than a predetermined number.

The low-frame image generation method has an advantage in terms of high speed processing. However, the image obtained by the low-frame image generation method may include a strong noise signal, and have a low signal-to-noise ratio (SNR).

FIG. 1B shows an image obtained by the conventional scanning method of the SEM. The image may be generated from a large number of frames. The method that generates an image with a large number of frames is called a high-frame generation method, in which the method is determined as the high-frame image generation method when the number of frames used for generating the image is larger than the predetermined number.

The high-frame generation method is a method that generates an image by measuring a large number of frames and then averaging them as shown in FIG. 1B.

The high-frame generation method may be slow in processing because it requires acquiring a large number of frames. In addition, since the electron beam needs to be repeatedly directed to the same region of the wafer sample, the target region of the wafer sample may be damaged by the electron beam.

However, the high-frame image generation method has an advantage in reducing noise signals because it obtains an image by averaging a large number of frames. Therefore, the output image obtained by using the high-frame image generation method may feature a high signal-to-noise ratio (SNR).

According to an embodiment of the present disclosure, an image generation method for measuring patterns on the wafer sample may combine the advantages of the low-frame image generation method and the high-frame image generation method.

Hereinafter, an image generation method according to an embodiment of the present disclosure will be described in more detail with reference to the drawings.

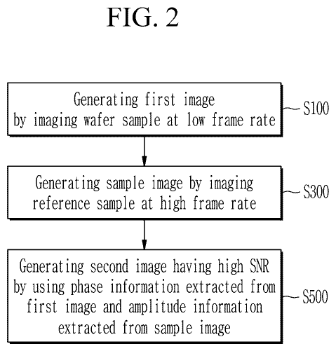

FIG. 2 is provided for description of an image generation method according to an embodiment.

An image generation method according to the present disclosure is a method for generating an image using a scanning electron microscope (SEM). Referring to FIG. 2, the image generation method may include generating a first image M1 by imaging a wafer sample at a low-frame rate (S100), generating a sample image MS by imaging a reference sample at a high-frame rate (S300), and generating a second image M2 having a high signal-to-noise ratio by using phase information extracted from the first image M1 and amplitude information extracted from the sample image MS (S500). The low frame rate indicates that a single frame or a small number of frames are used for imaging the wafer sample, and the high frame rate indicates that a large number of frames are used for imaging the wafer sample. For example, the low frame rate may include three or fewer frames for imaging the wafer sample, and the high frame rate may include more than three frames for imaging the wafer sample.

The method of generating an image of a wafer sample according to the present disclosure may acquire an image of the pattern of wafer sample by imaging the wafer sample at the low-frame rate.

A reference sample is characterized by having the same pattern as the wafer sample. Specifically, the reference sample may include a pattern shape that is similar to the pattern shape of the wafer sample. For example, the pattern shape may be a line and space, a hole shape, and the like. Both the pattern of the wafer sample and the pattern of the reference sample may have the same layout.

An image of the pattern of the reference sample may be obtained by imaging the reference sample with the same pattern of the wafer sample at the high frame rate. An amplitude information may be extracted from the high-frame image obtained by imaging the reference sample at the high frame rate.

By applying the amplitude information extracted from the high-frame image acquired from the reference sample to the low-frame image acquired from the wafer sample, noise of the low-frame image acquired from the wafer sample may be reduced. As a result of reducing the noise, the quality of the output image may be improved to the extent that the noise is reduced.

The image generated from the wafer sample by the low-frame image generation method may be a first image M1, and the image generated from the reference sample by the high-frame image generation method may be a sample image MS.

The first image M1, which is an image of the wafer sample obtained at a low frame rate, has a low signal-to-noise ratio (SNR), due to a significant portion of noise signal in an image signal obtained by scanning the wafer sample with the SEM, in which the noise signal is not distinguished from an actual pattern signal. Therefore, when the output image is generated only from the first image M1, an edge or a boundary of the pattern of the wafer sample may not be clear due to the noise signal, thereby causing measurement errors while measuring the pattern of the wafer sample.

According to the image generation method of the present disclosure, when the amplitude information extracted from the sample image MS is applied to the first image M1, a portion of the actual pattern signal in the image signal may be increased and a portion of the noise signal is reduced by the amplitude information, and the SNR increases. Accordingly, the edges or boundaries of the pattern become clear, and a measurement accuracy of the pattern measured in the output image may be improved.

According to the image generation method of the present disclosure, an image is generated by scanning the wafer sample using the low-frame image generation method. Because the processing time required for image generation is relatively short, damage to the pattern of the wafer sample can be minimized by minimizing the amount of electron beam injected into a scanning region of the wafer.

The reference sample is imaged using the high-frame image generation method that generates a large number of frames. Since the electron beam is injected onto the reference sample instead of the wafer sample at a high frame rate, the pattern of the wafer sample may not be damaged from the electron beam injection.

Because the phase information extracted from the first image M1 and the amplitude information extracted from the sample image MS are used for generating the second image M2, image generation may be improved if the number of patterns included in the first image M1 and the number of patterns included in the sample image MS are the same.

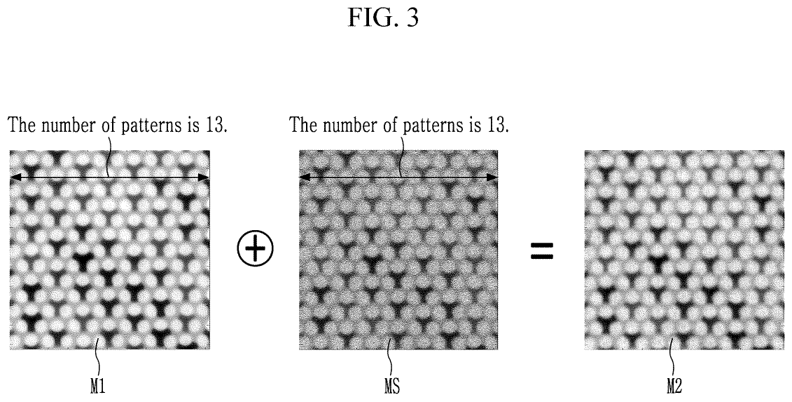

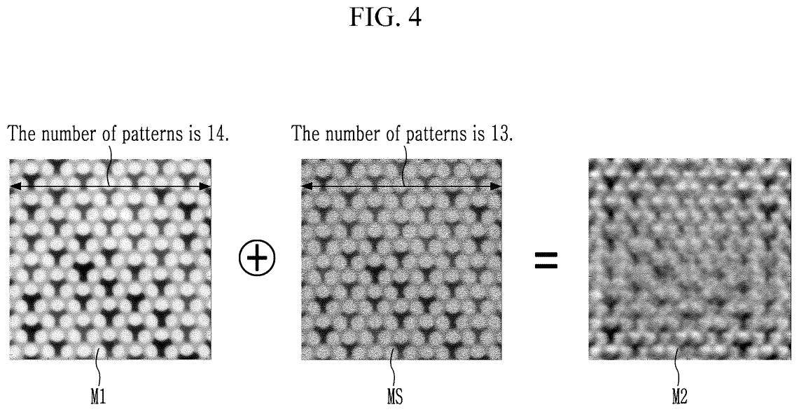

FIG. 3 is provided for description of a second image generated when the number of patterns of the first image and the number of patterns of the sample image are the same in the method according to FIG. 2, and FIG. 4 is provided for description of a second image generated when the number of patterns of the first image and the number of patterns of the sample image are different in the method according to FIG. 2.

For example, referring to FIG. 3, the number of patterns arranged in a width of the first image M1 in the horizontal direction is thirteen, and the number of patterns arranged in a width of the sample image MS in the horizontal direction is also thirteen.

When the same number of patterns are included in each of the first image M1 and the sample image MS, the second image M2 may be generated with a high-quality and reduced noise, and the second image M2 may contain the same number of patterns as the number of patterns in the first image M1.

On the other hand, referring to FIG. 4, the number of patterns arranged in a width of the first image M1 may be different from the number of patterns arranged in a width of the sample image MS. For example, the number of patterns arranged in a width of the first image M1 in the horizontal direction is fourteen, and the number of patterns arranged in a width of the sample image MS in the horizontal direction is thirteen.

When the number of patterns included in the first image M1 and the number of patterns included in the sample image MS are different, the generated second image M2 contains the same number of patterns as the first image M1, but a quality of the image may become lowered.

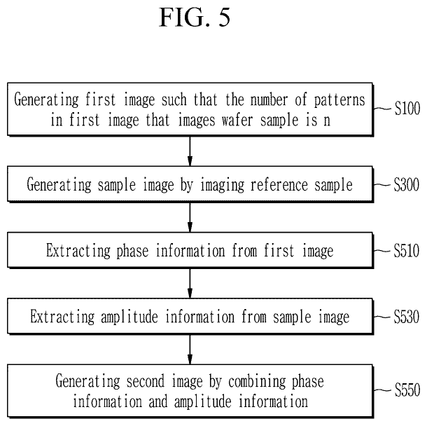

According to embodiments of the present disclosure, the second image M2 is generated by combining phase information extracted from the first image M1 and amplitude information extracted from the sample image MS. A method for extracting the phase information from the first image M1, a method for extracting the amplitude information from the sample image MS, and a method for generating the second image M2 using the phase information and the amplitude information will be described in detail hereinafter with reference to FIG. 5 to FIG. 9B.

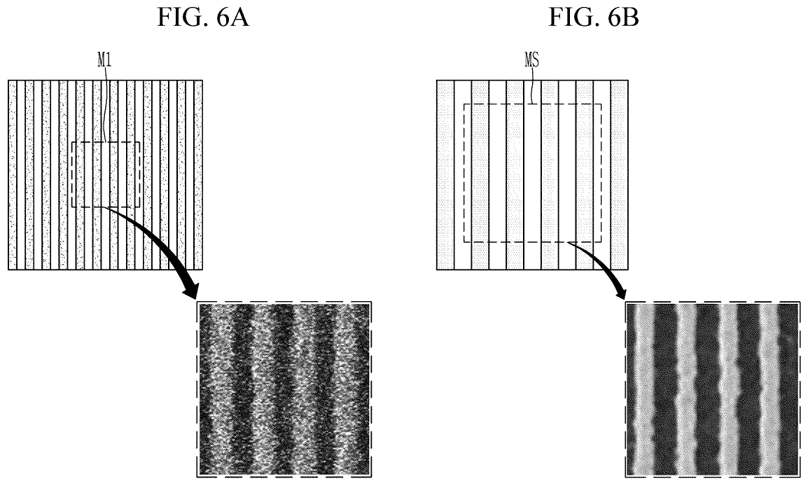

FIG. 5 is provided for description of the image generation method according to an embodiment, and FIG. 6A and FIG. 6B are provided for description of a process for generating the first image and the sample image using the image generation method according to an embodiment.

FIG. 5 is a detailed flowchart of the image generation method according to FIG. 2.

Referring to FIG. 5, the image generation method according to the present disclosure may be used for generating an SEM image. The image generation method may include generating a first image M1 by scanning a target region of the wafer sample, in which the number of patterns in the first image M1 is n, where n is natural number (S100), generating a sample image MS by imaging the reference sample (S300), extracting phase information from the first image M1 (S510), extracting amplitude information from the sample image MS (S530), and generating a second image M2 by combining the phase information and the amplitude information (S550). In the generated second image M2, the noise signal has been reduced compared with the noise single of the first image M1. Accordingly, the second image M2 may have a high signal-to-noise ratio (SNR).

The image generation method according to the present disclosure is featured to image the first image M1 at a low frame rate with a short image processing time, and image the sample image MS at a high frame rate with a long image processing time.

A low-frame image generation method may be used for generating the first image M1 from the wafer sample. The time required to generate the first image M1 may be shorter compared with the time required to generate the sample image MS, and the damage to the wafer pattern may be minimized.

By generating a high-frame image for the reference sample, in which the pattern disposed on the reference sample is the same as the pattern of the wafer sample, and applying the amplitude information extracted therefrom to the first image M1 for generating the second image M2, the noise signal of the second image M2 may be reduced.

Because the SEM injects electrons while generating the sample image MS, the reference sample may be damaged due to the electron beam. In order to minimize damage to the reference sample, the reference sample may be doped with an impurity or coated with metal before being scanned by SEM for generating the sample image MS (S300).

In the low-frame image of the wafer, the phase information, which is the position information of the pattern, is extracted, and in the high-frame image of the sample, the amplitude information, which is the intensity information of the signal, is extracted. By combining the phase information and the amplitude information, the noise signal may be reduced in the output image.

FIG. 6A shows a region of the wafer sample to be scanned by SEM, and FIG. 6B shows a region of the reference sample to be scanned by SEM. Each region to be imaged by SEM is indicated by a dashed box.

In FIGS. 6A and 6B, the first image M1 generated from the wafer sample and the sample image MS generated from the reference sample are shown.

As shown in FIGS. 6A and 6B, the number of patterns included in the first image M1 and the number of patterns included in the sample image MS may be the same. Specifically, the first image M1 and the sample image MS each contains four line and space patterns respectively.

Since the first image M1 and the sample image MS contain the same number of patterns, frequency matching as described below can be achieved.

As shown in FIG. 5, the sample image MS may be generated by the image generation method, in which the number of patterns included in the sample image MS is n, where n is a natural number. For example, the number of patterns included in the first image M1 and the sample image MS is four respectively.

A first gap s1 between the line patterns included in the first image M1 and a second gap s2 included in the sample image MS may be different from each other. Although optimally, the number of patterns included in the first image M1 and the sample image MS is the same, the spaces between the patterns does not need to be the same.

The number of pixels in the first image M1 and the number of pixels in the sample image MS may be the same.

Although optimally the number of pixels in each image is the same, image sizes of the first image M1 and in the sample image MS may be different. Because the image size is determined as the product of the number of patterns and the pattern spacing, if the spaces between the patterns are different, the image size will also be different.

In order to compare the first image M1 and sample image MS in the same frequency space, it is assumed that the number of patterns and pixels of the first image M1 and sample image MS are the same.

As the image sizes of the first image M1 and the sample image MS are different, the image size information may be removed and the phase information and amplitude information may be extracted through Fourier transform according to the number of pixels.

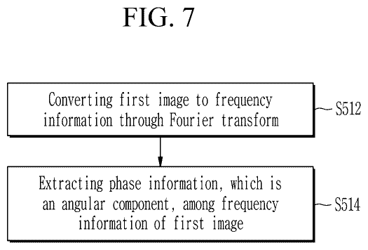

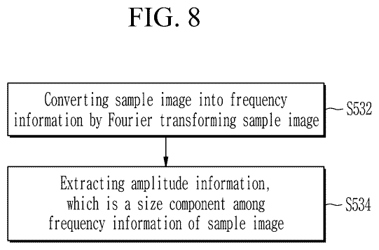

FIG. 7 is provided for description of a method for extracting phase information from the first image in the image generation method according to an embodiment, and FIG. 8 is provided for description of a method for extracting amplitude information from the sample image in the image generation method according to an embodiment.

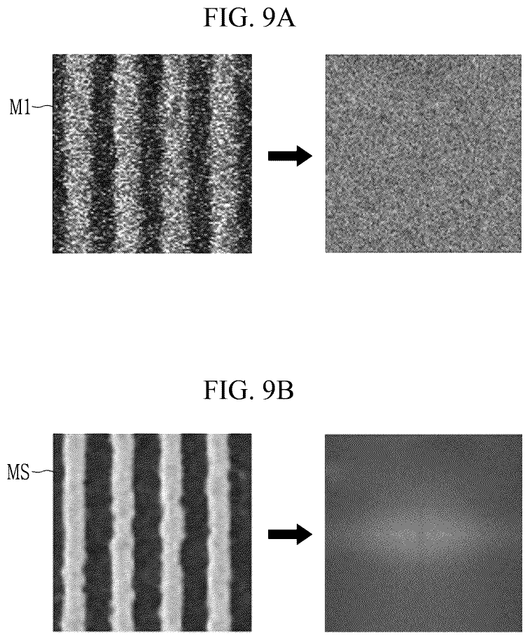

FIG. 9A is provided for description of phase information extracted according to FIG. 7, and FIG. 9B is provided for description of amplitude information according to FIG. 8.

By performing a Fourier transform on each image, the image information may be converted into frequency information, which is 2D information. The frequency information may include phase information which is an angular component, and amplitude information which is a size component.

Referring to FIG. 7 and FIG. 9A, the extracting the phase information from the first image M1 may include converting the first image M1 to frequency information through Fourier transform (S512) and extracting the phase information, which is an angular component, among the frequency information of the first image M1 (S514). The phase information may be information that represents position information of the pattern of the wafer sample.

The amplitude information with a large noise signal, among the frequency information of the first image M1, may not be used.

Referring to FIG. 8 and FIG. 9B, the extracting amplitude information from the sample image MS (S530) may include converting the sample image MS into frequency information by Fourier transforming the sample image MS (S532), and extracting the amplitude information, which is a size component among the frequency information of the sample image MS (S534).

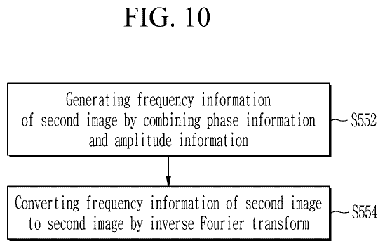

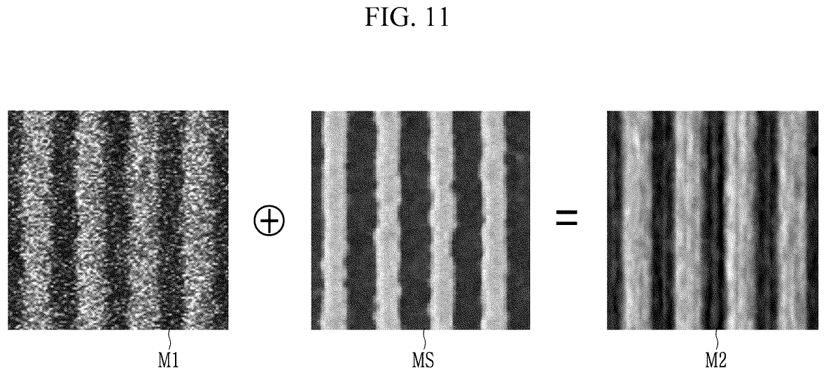

FIG. 10 is provided for description of a method for generating the second image in the image generation method according to an embodiment, and FIG. 11 is provided for description of a process for generating the second image using the image generation method according to FIG. 10.

Referring to FIG. 10, the generating the second image M2 (S550) may include generating frequency information of the second image M2 by combining the phase information and the amplitude information described with reference to FIG. 7 to FIG. 9B (S552). In addition, the generating the second image M2 (S550) may include converting the frequency information of the second image M2 into the second image M2 by inverse Fourier transform (S554) which converts the frequency information of the second image M2 back to the phase information of the second image M2.

The generating the second image M2 (S550) may include obtaining the second image M2 from the frequency information by proceeding to determine an inverse Fourier transform, through which the method reverses the process of obtaining the frequency information from the first image M1 and the sample image MS.

After generating the second image M2, measuring the pattern included in the second image M2 may further be included.

FIG. 11 shows the second image M2 generated by combining the first image M1 generated by the low-frame image generation method and the sample image MS generated by the high-frame image generation method.

The second image M2 may feature a high-quality image similar to the sample image MS while maintaining the pattern position (phase information) of the first image M1.

FIG. 11 shows the first image M1 and sample image MS, in which the phase information of the first image M1 and the amplitude information of the sample image MS shown in FIG. 9A and FIG. 9B are combined to produce the second image M2.

By applying the amplitude information of the sample image MS to the first image M1, the noise signal in the first image M1 may be reduced, and the pattern size and overlay may be measured more accurately.

For extracting phase information and amplitude information at the same frequency, where the number of patterns in the first image M1 and the number of patterns in the sample image MS are the same, the following procedure may be followed.

When a pattern spacing or a pattern period of the wafer sample is A nm, a pattern period of the reference sample is B nm, and each number of patterns in the wafer sample and the reference sample is four respectively, for example, each pixel number in the first image M1 and the sample image MS may be 512×512 respectively. Accordingly, the size of the sample image MS generated from the reference sample is 4B×4B nm², and the size of the first image M1 generated from the wafer sample is 4A×4A nm².

The size of one pixel of the sample image MS is (4B×4B)/(512×512) nm², and the size of one pixel of the first image M1 is (4A×4A)/(512×512) nm².

Although the pixel sizes of the sample image MS and the first image M1 are different, the number of patterns and pixels included in each image are the same. Accordingly, by removing the pixel size information from each of sample image MS and the first image M1, the two images may be in the same frequency domain with the same pixel count space, and frequency comparison between the two images may become possible. Images in the same frequency domain may exchange their frequency amplitude information and phase information.

The noise signal of the first image M1, which is a low-frame image that images the wafer sample, is larger than the noise signal of the sample image MS, which is a high-frame image that images the reference sample. Accordingly, by using the frequency amplitude information of the sample image MS, the noise signal can be reduced from the first image M1 to generate the second image M2. In addition, the second image M2 may maintain the phase information of the first image M1.

For example, in the process of generating the sample image MS using the high-frame image generation method, a 128-frame image may be obtained, in which the image features a high signal-to-noise ratio. The 128-frame image indicates that 128 frames are used for generating a single sample image MS.

In the process of generating the first image M1 using the low-frame image generation method, one frame may be used for generating a single first image M1. Alternatively, a small number of frames may be used for generating a first image M1. For the low-frame image generation method, the number of frames used for generating the first image M1 is equal to or smaller than a predetermined number. As the number of frames is decreased for generating the first image M1, the processing speed becomes faster and a wider region of the wafer sample can be imaged with short processing time. For example, the predetermined number may be three.

However, the first image M1 generated by the low-frame image generation method has low the signal-to-noise ratio (SNR), causing an image pattern shape to be blurry, and measuring accuracy while measuring the width or overlay of the pattern may be reduced. According to an embodiment, in order to increase the SNR of the first image M1, frequency-specific amplitude information extracted from the sample image MS, which is a high-frame image, may be applied to the first image M1.

By performing a Fourier transform on the sample image MS in the x and y directions, two-dimensional (2D) frequency information may be obtained. The frequency information may include amplitude information and phase information of a specific function. The amplitude information may be extracted from the specific function.

In the sample image MS with high SNR, a pattern-related frequency signal has a large amplitude and the noise signal has a small amplitude. By removing the noise signal from the first image M1 and adopting the amplitude information of the sample image MS, noise in the sample image MS may be reduced.

The shape and position of the pattern are determined by the phase information of the frequency information, and the phase information may be extracted from the first image M1, which is a low-frame image.

The phase information from the first image M1 may be obtained from 2D frequency information by performing Fourier transform in the x and y directions and extracting phase information from a specific function.

A high-quality second image M2 can be obtained by extracting amplitude information from the sample image MS and phase information from the image M1, and combining the two information to perform inverse Fourier transform.

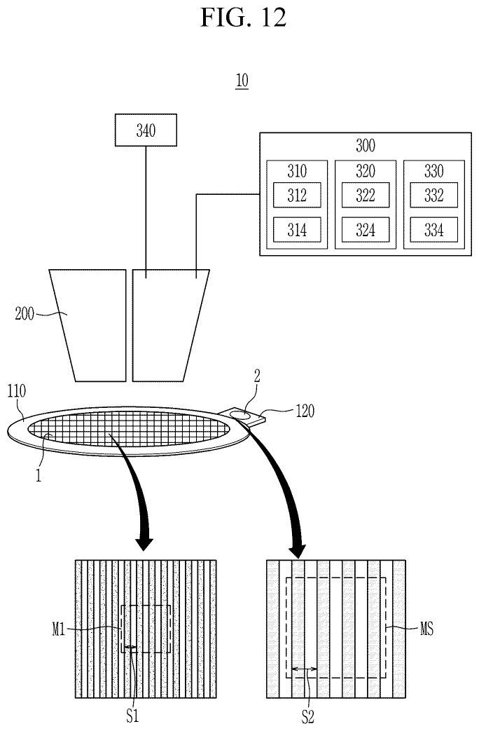

FIG. 12 is provided to describe an image generation device that generates an image using the image generation method according to the present disclosure.

Referring to FIG. 12, an image generating device 10 for generating an image according to the present disclosure may be an image generating device 10 using a scanning electron microscope (SEM) 200.

The image generating device 10 may include a first stage 110 for placing a wafer 1, a second stage 120, which is disposed close to first stage 110 and places a sample 2 parallel to the wafer 1, the SEM 200 generating a first image M1 of the wafer 1 and a sample image MS of the sample 2, and an imaging unit 300 that generates a second image M2 from which a noise signal is removed from the first image M1 by combining phase information of the first image M1 and amplitude information of the sample image MS.

The SEM 200 may generate the first image M1 and the sample image MS, in which the number of patterns in the sample image MS is the same as the number of patterns in the first image M1.

The imaging unit 300 may include a phase extractor 310 that extracts phase information from the first image M1, an amplitude extractor 320 that extracts amplitude information from the sample image MS, and an image generator 330 that combines the phase information and the amplitude information to generate the second image M2.

The phase extractor 310 may include a first converter 312 and a first extractor 314.

The first converter 312 may serve to convert the first image M1 into frequency information by performing Fourier transform on the first image M1, and the first extractor 314 may serve to extract the phase information, which is an angular component of the frequency information of the first image M1.

The amplitude extractor 320 may include a second converter 322 and a second extractor 324.

The second converter 322 may serve to convert the sample image MS into frequency information by performing Fourier transform on the sample image MS, and the second extractor 324 may serve to extract amplitude information, which is a size component among the frequency information of the sample image MS.

The image generator 330 may include a frequency generator 332 and a third converter 334.

The frequency generator 332 may serve to generate frequency information of the second image M2 by combining the phase information and the amplitude information, and third converter 334 may serve to convert frequency information of the second image M2 into the second image M2 by performing inverse Fourier transform on the frequency information.

The phase extractor 310, the amplitude extractor 320, and the frequency generator 332 may be implemented with several semiconductor transistors to function as a logic circuit by receiving input signals and providing output signals based on the input signals.

The image generation method according to the present disclosure may further include loading the wafer 1 onto the first stage 110 prior to generating the first image M1, and may further include loading the sample 2 onto the second stage 120 prior to generating the sample image MS.

In addition, after measuring the pattern of the second image M2 in a pattern measurement unit 340, the image generation method may further include unloading the wafer 1 from the first stage 110.

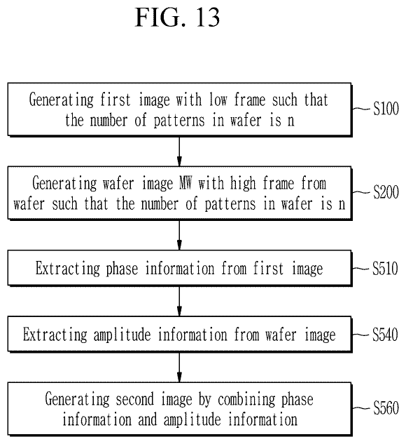

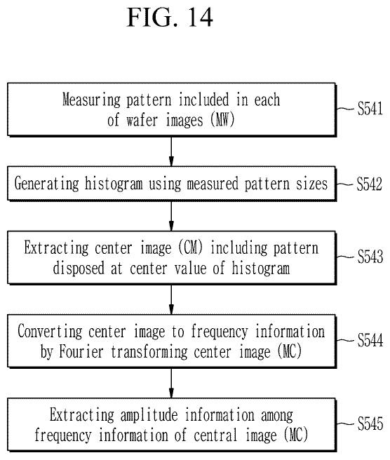

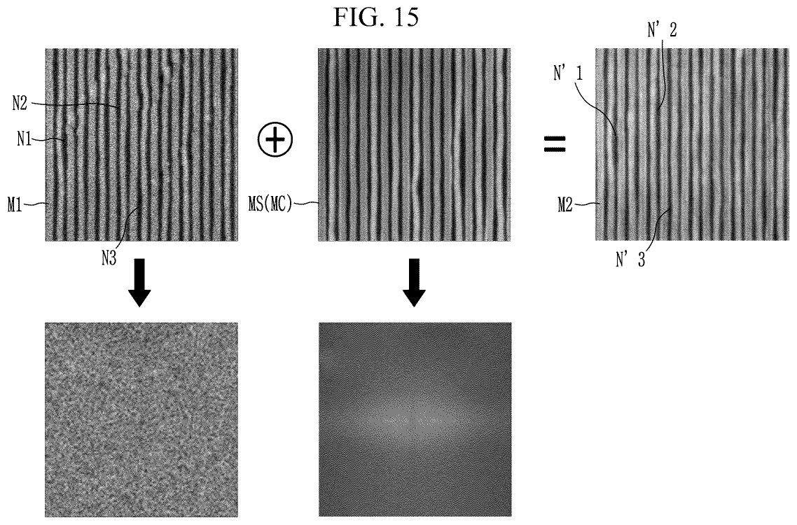

FIG. 13 is provided for description of an image generation method according to another embodiment, FIG. 14 is provided for description of a process for extracting amplitude information in the image generation method of FIG. 13, and FIG. 15 is provided for description of a process for generating a second image using the image generation method of FIG. 13.

In the image generation method of FIG. 2 to FIG. 11, the sample image MS is generated by imaging the reference sample at a high frame rate for a high-frame image. On the other hand, in the image generation method described with reference to FIG. 13 to FIG. 15 a wafer image MW is generated by imaging a wafer sample rather than imaging the reference sample at a low frame rate for a low-frame image.

Referring to FIG. 13, a method for generating a wafer image using an SEM according to the present disclosure may include generating a first image M1 at a low frame rate, in which the number of patterns in a wafer sample is n, where n is natural number (S100), generating a wafer image MW at a high frame rate from the wafer sample, in which the number of patterns in the wafer is n (S200), extracting phase information from the first image M1 (S510), extracting amplitude information from the wafer image MW (S540), and generating a second image M2 by combining the phase information and the amplitude information (S560).

When both the amplitude information and the phase information are extracted from a wafer sample, an image generated by a low-frame image generation method is called a first image M1, and an image generated by a high-frame image generation method is called a wafer image MW.

The extracting the phase information from the first image M1 (S510) may include converting the first image M1 to frequency information of the first image M1 by Fourier transform (S512) and extracting phase information, which is an angular component among the frequency information of the first image M1 (S514) (refer to FIG. 7).

Referring to FIG. 14, the extracting the amplitude information from the wafer image MW (S540) may include measuring patterns included in a plurality of wafer images MW respectively (S541), extracting a center image MC among the plurality of wafer images MW by utilizing a size of the measured patterns (S542 and S543), converting the center image MC to frequency information by performing Fourier transform on the center image MC (S544), and extracting amplitude information, which is a size component among the frequency information of the center image MC (S545). Alternatively, extracting the amplitude information from the wafer image MW (S540) may include measuring patterns included in a plurality of frame images, in which the wafer image MW is generated from the plurality of frame images.

The generating the center image MC may include generating a histogram using the size of the measured patterns (S542) and extracting the center image MC including a pattern positioned at a center value of the histogram (S543).

The center image MC is positioned at the center (corresponding to an ideal value) in the histogram composed of pattern sizes, and may be an image that contains a pattern size that is the average among various pattern sizes.

The generating the second image M2 (S560) may include generating frequency information of the second image M2 by combining the phase information and the amplitude information and converting the frequency information of the second image M2 to a second image M2 by performing inverse Fourier transform. The generating the second image M2 (S560) may further include measuring a pattern included in the second image M2.

FIG. 15 illustrates the second image M2 generated by combining the first image M1 generated by the low-frame image generation method and the wafer image (specifically, the center image MC) generated by the high-frame image generation method.

The phase information may be extracted from the first image M1 generated at the low frame rate, the amplitude information may be extracted from the wafer image MW at a high frame rate, and then the phase information and the amplitude information are combined to generate the second image M2. The image quality of the second image M2 may be similar to image quality of the wafer image MW which features a high quality, while maintaining the pattern position of the first image M1. Referring to FIG. 15, the pattern shape included in the first image M1 is also maintained in the second image M2 while noise from a noise signal is reduced.

In the process of obtaining the wafer image MW using the high-frame image generation method, damage or deformation of the wafer sample may be induced due to the electron beam. Therefore, it is preferable to obtain high-frame images from doped silicon or metal materials with good conductivity.

In the image generation method of FIG. 2 to FIG. 11, the wafer sample is used for the low-frame image generation method to obtain the first image M1, and the reference sample is used for the high-frame image generation method to obtain the sample image MS. In the image generation method of FIG. 2 to FIG. 11, the number of patterns and pixels in each image may be the same.

However, in the image generation method of FIG. 13 to FIG. 15, there is a difference in that the first image M1 is obtained from the wafer sample using the low-frame image generation method, and the wafer image MW is obtained from the wafer sample using the high-frame image generation method.

The noise signal in the first image M1 may be removed by applying amplitude information of the wafer image MW, which is a high-frame image imaged separately. The number of patterns, number of pixels, pattern spacing, and image size included in the first image M1 and the wafer image MW may be the same. Accordingly, the conditions for generating the first image M1 and the wafer image MW are the same except for the number of frames.

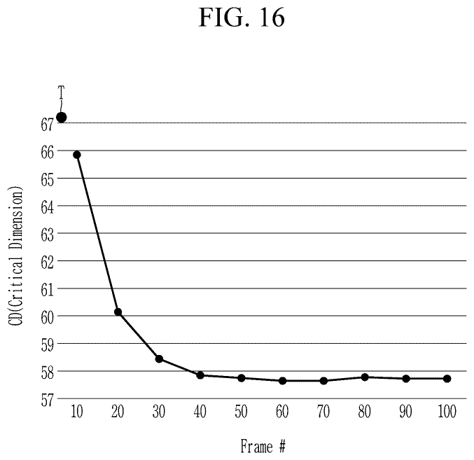

FIG. 16 is provided for description of the degree of change in a critical dimension (CD) according to the number of frames for image generation.

FIG. 16 is a graph for describing how to minimize wafer damage by using the low-frame image generation method.

Referring to the graph, it may be observed that the CD decreases as the number of frames increases. The CD refers to a line width, a hole size, various lengths, and areas of semiconductor microstructures that cannot be seen with the naked eye. An after develop inspection (ADI) result shows that the CD changes by several nanometers (nm) depending on the amount of electron beam injected.

This means that as the number of frames increases, the amount of electron beam injected into the wafer increases, and the degree of change in CD increases.

The image generation method according to the present disclosure is characterized in that the first image M1, which is generated by measuring the pattern of the wafer sample, is acquired through the low-frame image generation method. As a result, the image generation method according to the present disclosure can minimize damage to the wafer by using the low-frame image generation method with a small number of frames, such as the position of T shown in FIG. 16. In addition, the first image M1 can be obtained at high speed.

Simultaneously, a high-quality image with a high signal-to-noise ratio can be generated by removing the noise signal of the first image M1 using the sample image MS and the wafer image MW generated separately using the high-frame image generation method.

Although the present disclosure has been described above with regard to a preferred embodiment, it is not limited thereto, and it is possible to implement it by modifying it in various ways within the scope of the patent claims and the detailed description and accompanying drawings, and this also naturally falls within the scope of the present disclosure.

What is claimed is:

1. An image generation method that generates an image using a scanning electron microscope, the method comprising:
generating a first image by imaging a wafer sample at a low frame rate;
generating a sample image by imaging a reference sample at a high frame rate; and
generating a second image using phase information extracted from the first image and amplitude information extracted from the sample image, in which a signal-to-noise ratio of the second image is higher than that of the first image,
wherein the number of patterns included in the first image and the number of patterns included in the sample image are the same.

2. The image generation method of claim 1, wherein, at the low frame rate, the first image is generated from a single frame imaging the wafer sample, and at the high frame rate, the sample image is generated from multiple frames imaging the reference sample.

3. The image generation method of claim 1, wherein, at the low frame rate, the first image is generated from a first number of frames imaging the wafer sample, and at the high frame rate, the sample image is generated from a second number of frames imaging the reference sample, and the first number is smaller than or equal to a predetermined value and the second number is larger than the predetermined value.

4. An image generation method that generates an image using a scanning electron microscope, the method comprising:
generating a first image by imaging a wafer sample, in which the first image includes a first number of patterns;
generating a sample image by imaging a reference sample, in which the sample image includes a second number of patterns;
extracting phase information from the first image;
extracting amplitude information from the sample image; and
generating a second image using the phase information and the amplitude information,
wherein the first number and the second number are the same.

5. The image generation method of claim 4, wherein the first image and the sample image include the same number of pixels.

6. The image generation method of claim 4, wherein a signal-to-noise ratio of the second image is higher than that of the first image.

7. The image generation method of claim 4, wherein the scanning electron microscope captures the first image at high speed with a low frame rate, and the sample image at low speed with a high frame rate respectively.

8. The image generation method of claim 7, wherein, at the low frame rate, the first image is generated from a single frame imaging the wafer sample, and at the high frame rate, the sample image is generated from multiple frames imaging the reference sample.

9. The image generation method of claim 7, wherein, at the low frame rate, the first image is generated from a first number of frames imaging the wafer sample, and at the high frame rate, the sample image is generated from a second number of frames imaging the reference sample, and the first number is smaller than or equal to a predetermined value and the second number is larger than the predetermined value.

10. The image generation method of claim 4, further comprising,
before generating the sample image, doping or metal coating the reference sample.

11. The image generation method of claim 4, wherein, the extracting the phase information from the first image comprises:
converting the first image into frequency information by Fourier transforming the first image; and
extracting the phase information, which is an angular component of the frequency information of the first image.

12. The image generation method of claim 4, wherein the extracting the amplitude information from the sample image comprises:
converting the sample image into frequency information by Fourier transforming the sample image; and
extracting amplitude information, which is a size component of the frequency information of the sample image.

13. The image generation method of claim 4, wherein the generating the second image comprises generating frequency information of the second image by combining the phase information and the amplitude information.

14. The image generation method of claim 13, wherein, the generating the second image comprises converting the frequency information of the second image to the second image by inverse Fourier transforming the frequency information of the second image.

15. An image generation method using a scanning electron microscope, comprising:
generating a first image at a low frame rate from a wafer sample;
generating a wafer image at a high frame rate from the wafer sample;
extracting phase information from the first image;
extracting amplitude information from the wafer image; and
generating a second image using the phase information and the amplitude information.

16. The image generation method of claim 15, wherein, the extracting the phase information from the first image comprises:
converting the first image into frequency information by Fourier transforming the first image; and
extracting the phase information, which is an angular component of the frequency information of the first image.

17. The image generation method of claim 15, wherein, the extracting the amplitude information from the wafer image comprises:
measuring a pattern included in a plurality of frame images, in which the wafer image is generated from the plurality of frame images;
extracting a center image from the plurality of frame images by utilizing a size of the measured plurality of patterns;
converting the center image into frequency information by Fourier transforming the center image; and
extracting amplitude information, which is a size component of the frequency information of the center image.

18. The image generation method of claim 17, wherein, the extracting the center image comprises:
generating a histogram using the size of the measured plurality of patterns; and
extracting a center image including a pattern positioned at a center value of the histogram.

19. The image generation method of claim 15, wherein, the generating the second image comprises:
generating frequency information for the second image by combining the phase information and the amplitude information from the first image and the wafer image respectively; and
applying the frequency information for the second image to the second image by inverse Fourier transforming the frequency information for the second image.

20. The image generation method of claim 15, wherein, at the low frame rate, the first image is generated from a single frame imaging the wafer sample, and at the high frame rate, the sample image is generated from multiple frames imaging the wafer sample.
